(19) United States
(12) Patent Application Publication
(10) Pub. No.: US 2013/0332247 A1
(43) Pub. Date: Dec. 12, 2013

(54) BAR CODE BASED RECYCLING

(71) Applicant: Yansong Gu, Bellevue, WA (US)

(72) Inventor: Yansong Gu, Bellevue, WA (US)

(73) Assignee: Empire Technology Development LLC

(21) Appl. No.: 13/639,061

(22) PCT Filed: Jun. 8, 2012
(86) PCT No.: PCT/US12/41557

§ 371 Date: Oct. 2, 2012

(51) Int. Cl. G06Q 30/02

(52) U.S. Cl. 705/14.11

(57) ABSTRACT

Methods, systems, and apparatuses, including computer programs encoded on computer-readable media, for scanning a barcode on an article to obtain article recycling information. A first incentive is received based upon the scanning of the article and a second incentive is received based upon verification that the article was recycled.

### BACKGROUND

The following description is provided to assist the understanding of the reader. None of the information provided or references cited is admitted to be prior art.

Recycling reflects the level of civilization in a society. While there is no question about its importance for reasons of environmental preservation, the actual practice may not be as desirable as it could be due to various technical and economic reasons. For example, the recycling business may not be as profitable for market players because some recycled materials are not necessarily cheaper than the corresponding virgin materials. In those cases, the cost of recycling such materials is mainly associated with logistics efforts, i.e., a lower recycling rate may be due to the lower rate of consumer participation. In addition, sorting the material to be recycled can be labor intensive, and ineffective sorting techniques and practices can lead to undesirable waste and added waste in recycling materials.

### SUMMARY

In general, one aspect of the subject matter described in this specification can be embodied in methods for scanning a barcode on an article to obtain article recycling information. The method further includes receiving a first incentive based upon the scanning of the article and receiving a second incentive based upon verification that the article was recycled. In various embodiments, the article recycling information can include, among others, a recycling instruction, a material property that the article comprises, a recycling container identifier for the article, identification of one or more type of materials from which the article is made, an indication that the material is bio-decomposable, and/or an indication that the material is biodegradable.

In another implementation, the method can also include scanning recycling container information from a recycling container. The recycling container information can identify the recycling container.

In yet another implementation the first incentive is initially inactive. The first incentive is activated based upon the verification that the article was recycled. In addition, the first incentive can be verified based upon sending weight data associated with recycled articles and a consumer identifier to a remote server.

In one implementation, an article identifier and a consumer identifier are sent to a remote device. A third incentive can be received from the remote server.

In another implementation, an article identifier is included in the scanned data. The article identifier can be sent to a remote server and further article recycling information can be received in response.

In other implementations, the value of the first incentive can be based upon the value of material from which the article is made. In some implementations, the second incentive is a garbage collection credit. The garbage collection credit can be based on a weight of the article, a value of material that the article comprises, or a combination thereof.

Other implementations include corresponding systems, apparatuses, and computer-readable media configured to perform the actions of the various methods.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings. Like reference numbers and designations in the various drawings indicate like elements.

FIG. 1 illustrates a recycling system in accordance with an illustrative embodiment.

FIG. 2 illustrates a recycling process in accordance with an illustrative embodiment.

FIG. 3 is a flow diagram of a recycling process in accordance with an illustrative embodiment.

FIG. 4 is a block diagram of a computer system in accordance with an illustrative implementation.

### DETAILED DESCRIPTION

Described herein are illustrative methods and apparatuses relating to providing one or more incentives to encourage recycling of various articles, such as, but not limited to, e.g., consumer products. Article information can be determined from information scanned or received from the article. For example, a radio-frequency identification tag can provide data. In other implementations, a barcode can be scanned to provide data. The received data can be used to receive information and/or incentives. For example, information relating to where the article should be recycled, what materials the article is made of, if the material is biodegradable, bio-decomposable, etc. A biodegradable material is one that can be broken down in a biological system. A bio-decomposable material is a material that can be broken down by a biological organism. All materials are bio-decomposable. The time for a material to decompose, however, can vary tremendously from a matter of hours to thousands of years. Not all materials, however, are biodegradable. The received data can also be used to receive one or more incentives. Incentives can be received from various parties, such as, but not limited to, e.g., a manufacturer of the article, a recycler, a retailer, government entity, etc. The incentives can include various incentives, e.g., a coupon for the article, a coupon for other articles associated with the article, a credit for garbage collection service, points toward incentives, an instant rebate, a honorary recognition, a cash reward, a tax benefit, etc.

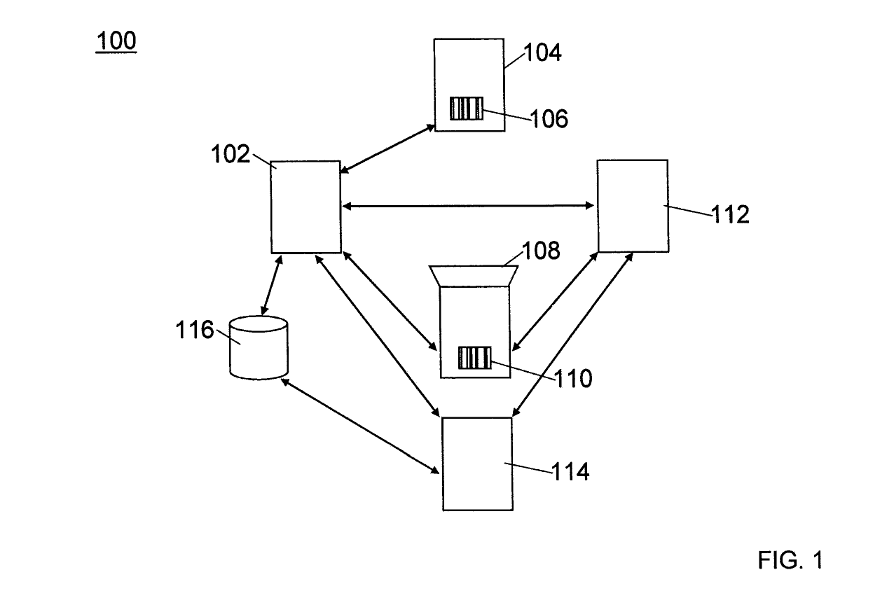

FIG. 1 illustrates a recycling system in accordance with an illustrative embodiment. The recycling system includes a computing device 102. The computing device 102 can be a smart device, a mobile phone, a personal digital assistant (PDA), a tablet, etc. The computing device 102 can receive data from an article 104, e.g., a consumer product. In one implementation, the computing device 102 can include a scanner (not shown). The scanner can scan a barcode 106 associated with the article to generate barcode data. The barcode 106 can be a 1D barcode, a 2D barcode, an optical barcode, an acoustic barcode, a resonant barcode, etc. The scanner can provide barcode data to the computing device 102. In another implementation, the computing device 102 can include a radio-frequency identification (RFID) receiver. In this implementation, the article 104 can include a RFID tag that provides data to the computing device 102 through the RFID receiver. In yet another implementation, the computing device 102 can include both the scanner and the RFID receiver, and the article 104 can include either or both a barcode 106 and a RFID tag.

Using the data associated with the article 104, the computing device 102 can obtain article recycling information. Article recycling information can include, but is not limited to, a material property of the article; a recycling container identifier for the article; a recycling instruction; identification of materials within the article; whether the article is bio-decomposable and/or biodegradable; polymer information; a thermoplastics or thermosetting polymer indication; a type of polymer; an indication if a polymer is derived from biomass or petroleum; an indication if the polymer is virgin material or recycled material and can include the generation, etc. In one implementation, the article recycling information can be contained within a 2D barcode. In another implementation, the data from the article can be used to look up article recycling information associated with the article. For example, the data from the article can include an article identifier. The article identifier can be used to query for relevant article recycling information. In another implementation, the data can include an article recycling information identifier that is used to retrieve the article recycling information. The article recycling information can be presented to the user to instruct the user on how to recycle the article, where to recycle the article, future incentives for recycling the article, etc.

In one implementation, the computing device 102 can include an application. This application can use the article identifier to query a data store 116 for the article recycling information. The data store 116 can be located on the computing device 102 or a remote computing device 114 and can map the article identifier to the associated article recycling information. The computing device 102 can send the data store 116 the article identifier and in response, receive the article recycling information. In another implementation, the data store 116 can map the article recycling information identifier to the associated article recycling information. In this implementation, the computing device 102 can send the data store 116 the article recycling information identifier and in response, receive the article recycling information.

The data associated with the article 104 can also be used to receive an incentive. For example, after receiving the data, the computing device 102 can send all or part of the data to a remote computing device 114. In response, the remote computing device 114 can provide an incentive to the consumer. For example, the remote computing device 114 can award the consumer points toward a coupon, product, etc. The points can then be redeemed for other incentives such as, but not limited to, e.g., coupons, free products, rebates, credits, cash, etc. In addition to the incentive, a recycler can provide the consumer an additional credit based upon the recycling of the article. This feature is described in greater detail below.

As indicated above, the article recycling information can include recycling instructions and/or a recycling container identifier. For example, the recycling container identifier can include a picture of the appropriate recycling container. In another implementation, the recycling container identifier can include a color that corresponds with the color of the appropriate recycling container. The recycling instructions may include an address of nearby recycling sites, for example, an eWaste recycling site The recycling instructions and/or the recycling container identifier help ensure that an article is properly recycled.

The computing device 102 can also receive data associated with a recycling container 108. In one implementation, the data can be scanned from a barcode 110 on the recycling container 108. In another implementation, the data can be received from an RFID tag associated with the recycling container 108. The data from the recycling container 108 can be associated with a consumer. For example, the data can include a user identifier that is associated with a consumer. Additionally, the data from the recycling container 108 can also identify the type of material that is associated with the recycling container 108.

A recycler can also have a computing device 112. The recycler can scan or obtain the data from the recycling container 108 using the computing device 112. As described above, the data can be retrieved by scanning the barcode 110 or from an RFID tag. The recycler can determine a consumer associated with the recycling container 108 based upon the data. In another implementation, the recycling container 108 does not include a barcode; rather, the recycler associates a recycling container 108 with a consumer based upon the address where the recycling container was picked up. Incentives provided to a consumer can be based upon verifying that the consumer recycled various articles; the amount of material recycled; and/or the type of material recycled. For example, a consumer can have multiple containers or a container with multiple compartments that are used to recycle articles. The recycler can weigh each container/compartment. Using this information, the recycler can provide an incentive to the consumer. In one implementation, the credit is based upon the amount, value, and/or type of material contained within the recycling container 108. For example, high-value materials can result in awarding a higher value incentive compared with lower value materials.

In another implementation, the recycler can verify that the consumer recycled various articles. The computing device 112 can send weight data corresponding to an amount of recycled material collected and consumer identification data to a remote computing device 114. The remote computing device 114 can have data associated with the items that were previously scanned by the consumer. Using weights associated with the previously scanned items, the remote computing device 114 can estimate if the consumer recycled the articles that were previously scanned. For example, the total weight of the previously scanned items can be compared with the weight data. If the weight data is greater or equal to the previously scanned items, the previously scanned items can be verified as recycled. The verification process can be done for each type of material and/or recycling container/compartment that is picked up by the recycler.

Once verified, an incentive can be sent to the consumer that is in addition to the incentive received for scanning the article. The value of this incentive can be based upon the weight and/or value of the recycled articles. In another implementation, the incentive for scanning the article is inactive until the recycling is verified. Upon verification the incentive can be activated. Accordingly, the incentive is not redeemable or active until the recycled articles are verified. In one implementation, the value of the activated incentive can be based upon the value of the recycled material. In addition, another incentive, as described above, can be awarded to the consumer. For example, an incentive, in addition to the two previously received incentives, can be received by sending the consumer identifier and article identifier to another computing device.

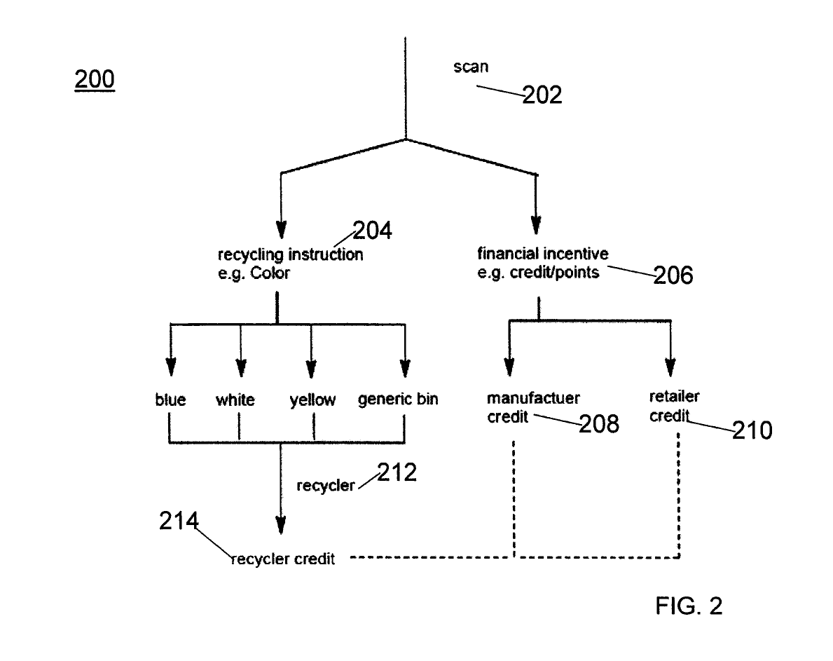

FIG. 2 illustrates a recycling process in accordance with an illustrative embodiment. Using a computing device a consumer can scan an article (202). For example, the consumer can use a smartphone to scan a barcode on an article. The smartphone can retrieve article recycling information and/or one or more financial incentives (206) based upon the scanning of the barcode. For example, data associated with the scanned barcode can include an article identifier or an article recycling information identifier. Either of these identifiers can be used to receive article recycling information associated with the article. The article recycling information can include recycling instructions (204). For example, the recycling instructions can indicate what color of recycling container the article should be placed in to be properly recycled.

A recycler (212) can, upon pickup of the container, provide a recycler credit (214) to the consumer. For example, the recycling container that is picked up can include a barcode. The barcode can contain data that is associated with a consumer. The recycler (212) can scan the barcode during the pickup of the recycling container. Using the barcode data, the consumer can be identified and a recycler credit can be awarded to the consumer.

The consumer can receive other incentives in addition to the recycler credit. For example, upon scanning of the article, data can be sent to a remote server. The data sent can include an article identifier based upon data scanned from the article and a consumer identifier. In one implementation, an application can send the data to the remote computer. The application can retrieve the consumer identifier from the computing device or request consumer identification information directly from the consumer. Upon receipt of this information, the remote computing device can provide the consumer with an incentive. In one implementation, the consumer can receive incentives from a manufacturer of the article and a retailer after sending the information to the remote server. In one implementation, the application uses the data scanned from the article to determine the location of the remote device. For example, a 2D barcode might provide a URL that is used to send data and obtain incentives. In another implementation, an article identifier can be used to look up a URL of the remote computing device associated with the article identifier.

Additional article recycling information can also be received from a remote server. In one implementation, the scanned data can contain some limited recycling information. For example, the article recycling information can include an identification of the material of the article. To retrieve additional article recycling information, an article identifier or a recycling information identifier can be sent to a remote server. In response, additional article recycling information can be retrieved.

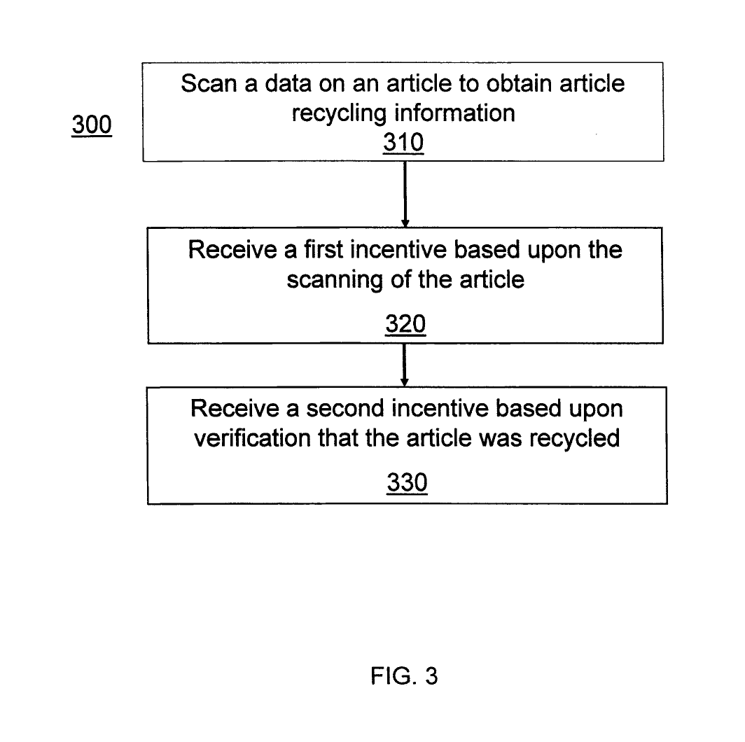

FIG. 3 is a flow diagram of a recycling process in accordance with an illustrative embodiment. The process 300 can be implemented on a computing device. In one implementation, the process 300 is encoded on a computer-readable medium that contains instructions that, when executed by a computing device, cause the computing device to perform operations of process 300.

The process 300 includes scanning data on an article to obtain article recycling information (310). As described above, the scanning of data can be done using a barcode scanner or an RFID receiver. The data can itself contain the article recycling information. In another implementation, the data can contain one or more identifiers that can be used to retrieve the article recycling information. Using the scanned data, a first incentive can be received (320). In one implementation, the incentive can be received in response to sending an identifier to a remote server or to a data store. A second incentive can be received based upon a verification that an article was recycled (330). In one implementation, verification includes comparing a weight of recycled material with weight of previously scanned articles. If the recycled weight is equal to or greater than the weight of the previously scanned articles, then the previously scanned articles are verified as being recycled.

### EXAMPLES

The present systems and methods will be understood more readily by reference to the following examples, which are provided by way of illustration and are not intended to be limiting in any way.

### Example 1

### Receiving Recycling Instructions

A smartphone application can be used to scan a barcode on a consumer product, e.g., a glass jar, a plastic bottle, a cardboard box, etc. In one implementation, the barcode can be a recycling barcode that contains the needed information. In another implementation, the barcode can be the UPC code. The scanned data can be used to identify recycling instructions associated with the consumer product. For example, a portion of the scanned data can be used to lookup the recycling instructions in a local or remote data store. The recycling instruction can identify the proper recycling container for the consumer product. For example, the recycling instruction can indicate the color of the proper recycling container. In addition to using the scanned data to determine associated recycling instructions, the smartphone application can send a portion or all of the scanned data to a remote computing device. The remote computing device can send an incentive based upon the received data. For example, the received data can be used to determine the manufacturer of the consumer product. In this example, the incentive can be a manufacturer's coupon. The value of the coupon can depend upon the recycling value of the consumer product. The recycling value of the consumer product can be determined based upon the proper recycling container used to recycle the consumer product.

### Example 2

### Valuing Incentives Based Upon Collected Material

The value of an incentive can also depend upon the amount of material recycled. The recycler can scan one or more barcodes on recycling containers when the materials within the recycling containers are collected. The scanned data from the recycling containers can be used to determine a customer associated with the recycling containers. For example, the scanned data can contain a customer identifier, customer address, etc. The weight of the recycled material can be determined and associated with the identified customer. Incentives provided to the customer can therefore depend upon the weight of the recycled material. For example, incentives can be issued to customers based upon the aggregate weight of recycled materials over a period of time.

### Example 3

### Other Incentives

Incentives from parties other than a manufacturer can also be delivered to a person. For example, a retailer may provide a credit, rebate, coupon, etc., based upon the scanned data being sent to a remote server. In addition, a recycler can provide a credit based upon the amount of recycled materials collected. A consumer can collect multiple incentives for scanning and properly recycling articles. For example, a consumer may scan a consumer product and recycle the consumer product correctly based upon the received recycling instructions. In addition, the consumer can receive a coupon from the manufacturer of the consumer product, the retailer of the consumer product, the recycler, coupons from another manufacturer, and/or coupons from another retailer.

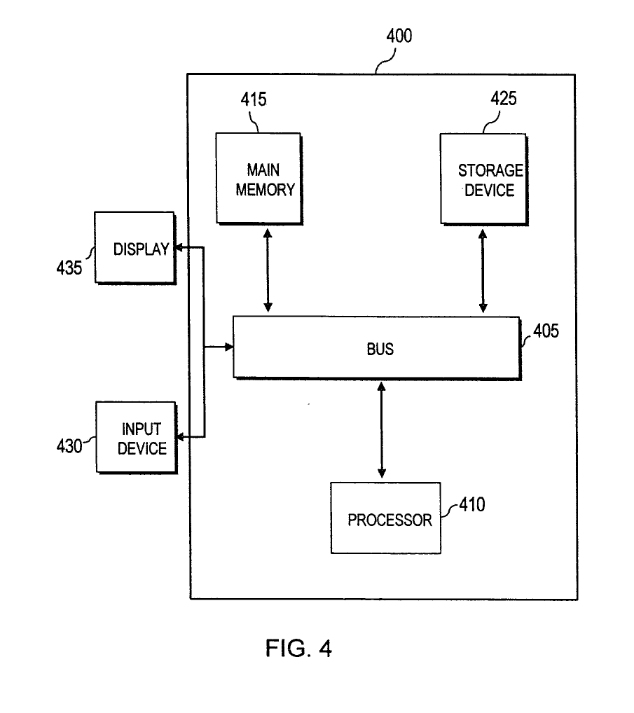

FIG. 4 is a block diagram of a computer system in accordance with an illustrative implementation. The computer system or computing device 400 can be used to implement the computing devices 102, 112, and/or, 114. The computing system 400 includes a bus 405 or other communication component for communicating information and a processor 410 or processing circuit coupled to the bus 405 for processing information. The computing system 400 can also include one or more processors 410 or processing circuits coupled to the bus for processing information. The computing system 400 also includes main memory 415, such as a random access memory (RAM) or other dynamic storage device, coupled to the bus 405 for storing information, and instructions to be executed by the processor 410. Main memory 415 can also be used for storing position information, temporary variables, or other intermediate information during execution of instructions by the processor 410. The computing system 400 may further include a read only memory (ROM) 410 or other static storage device coupled to the bus 405 for storing static information and instructions for the processor 410. A storage device 425, such as a solid state device, magnetic disk or optical disk, is coupled to the bus 405 for persistently storing information and instructions.

The computing system 400 may be coupled via the bus 405 to a display 435, such as a liquid crystal display, or active matrix display, for displaying information to a user. An input device 430, such as a keyboard including alphanumeric and other keys, may be coupled to the bus 405 for communicating information and command selections to the processor 410. In another implementation, the input device 430 has a touch screen display 435. The input device 430 can include a cursor control, such as a mouse, a trackball, or cursor direction keys, for communicating direction information and command selections to the processor 410 and for controlling cursor movement on the display 435.

According to various implementations, the processes described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. In alternative implementations, hard-wired circuitry may be used in place of or in combination with software instructions to effect illustrative implementations. Thus, implementations are not limited to any specific combination of hardware circuitry and software.

Although an example computing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

One or more flow diagrams have been used herein. The use of flow diagrams is not meant to be limiting with respect to the order of operations performed. The herein-described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Specific examples of “operably couplable” include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
scanning, using a scanner, data on an article to obtain article recycling information;
receiving a first incentive based upon the scanning of the article; and
receiving a second incentive based upon verification that the article was recycled.

2.-5. (canceled)

6. The method of claim 1, wherein the article recycling information comprises a recycling container identifier for the article.

7. The method of claim 1, further comprising scanning, using the scanner, recycling container information from a recycling container, wherein the article recycling information identifies the recycling container.

8. The method of claim 1, wherein the first incentive is initially inactive, and wherein the first incentive is activated based upon the verification that the article was recycled.

9. The method of claim 8, wherein the first incentive is verified based upon sending weight data associated with recycled articles and a consumer identifier to a remote server.

10. The method of claim 1, further comprising sending an article identifier and a consumer identifier to a remote server.

11. The method of claim 10, further comprising receiving a third incentive from the remote server.

12. The method of claim 1, wherein the scanned data comprises an article identifier.

13. The method of claim 12, further comprising:
sending the article identifier to a remote server; and
receiving further article recycling information in response.

14. (canceled)

15. (canceled)

16. The method of claim 1, wherein a value of the first incentive is based upon a value of material that the article comprises.

17. The method of claim 1, wherein the second incentive is a garbage collection credit.

18. The method of claim 17, wherein the garbage collection credit is based on a weight of the article, a value of material that the article comprises, or a combination thereof.

19.-21. (canceled)

22. A system comprising:
a scanner configured to:
scan data on an article to provide article recycling information; and
one or more processors configured to:
receive a first incentive based upon the scanning of the article recycling information; and
receive a second incentive based upon verification that the product was recycled.

23.-26. (canceled)

27. The system of claim 22, wherein the article recycling information comprises a recycling container identifier for the article.

28.-36. (canceled)

37. The system of claim 22, wherein a value of the first incentive is based upon a value of material that the article comprises.

38. The system of claim 22, wherein the second incentive is a garbage collection credit.

39.-42. (canceled)

43. A non-transitory computer-readable medium having instructions stored thereon, the instructions comprising:
instructions to scan data on an article to obtain article recycling information;
instructions to receive a first incentive based upon the scanning of the article recycling information: and
instructions to receive a second incentive based upon verification that the product was recycled.

44.-47. (canceled)

48. The system of claim 22, wherein the article recycling information comprises a recycling container identifier for the article.

49.-56. (canceled)

57. The non-transitory computer-readable medium of claim 43, wherein a value of the first incentive is based upon a value of material from the article

58. The non-transitory computer-readable medium of claim 43, wherein the second incentive is a garbage collection credit.

59.-62. (canceled)
